(19) United States
(12) Patent Application Publication
(10) Pub. No.: US 2026/0208646 A1
(43) Pub. Date: Jul. 23, 2026

(54) VEHICLE DOOR ASSEMBLIES WITH DOOR ARMRESTS HAVING FORE-AFT SLOTTING FOR IMPROVED COMFORT AND REDUCED COMPLEXITY

(71) Applicant: GM GLOBAL TECHNOLOGY OPERATIONS LLC, Detroit, MI (US)

(72) Inventors: Fernando A. Siqueira, Santo Andre (BR); Denis Y. Tanaka, Sao Caetano do Sul (BR); Bruno D. Cacace, Aracoiaba da Serra (BR)

(73) Assignee: GM GLOBAL TECHNOLOGY OPERATIONS LLC, Detroit, MI (US)

(21) Appl. No.: 19/033,543

(22) Filed: Jan. 22, 2025

(51) Int. Cl. B60N 2/75; B60R 13/02

(52) U.S. Cl. CPC B60N 2/78; B60R 13/0243; B60R 2013/0287

(57) ABSTRACT

Presented are vehicle armrests having fore-aft slotting for improved comfort and reduced complexity, methods for making/using such vehicle armrests, and vehicle door assemblies fabricated with such armrests. A vehicle armrest assembly for a motor vehicle includes an armrest substrate that attaches to an interior surface inside the passenger cabin of the motor vehicle, such as an interior trim panel of a vehicle door assembly. The armrest substrate includes an elastic substrate body with an elongated slot defined through the substrate body and extending along a fore-aft length of the armrest such that the armrest substrate elastically deforms under vertical loading conditions. A compressible pad is mounted on the armrest substrate and covers the substrate body and substrate slot. A flexible outer skin is mounted on and covers the compressible pad. Adjoining opposite terminal ends of the substrate slot is a pair of through-holes that guide deflection of the substrate body.

### INTRODUCTION

The present disclosure relates generally to armrest assemblies for motor vehicles. More specifically, aspects of this disclosure relate to vehicle door assemblies with interior door trim armrests for providing improved occupant comfort.

Many current production motor vehicles, such as the modern-day automobile, are originally equipped with driver-side and passenger-side vehicle doors that can be opened and closed to allow user access for entering and exiting the vehicle's passenger cabin. Some vehicle doors are designed as multilayer sandwich structures with an outer “A-surface” door panel that is mounted on the outboard side of a stamped sheet-metal support panel, and an interior trim panel that is mounted to the inboard side of the support panel to face into the passenger cabin. The door's various electrical and mechanical hardware components, such as the window lift subassembly, acoustic speakers, electrical harness, door lock assembly, etc., are packaged between these interconnected panels. To decrease the time and complexity associated with assembling the entire vehicle door, some or all of the foregoing hardware components can be preassembled onto a unit carrier to form a unitary subassembly, more commonly known as a “door hardware module.” In so doing, the unit carrier, together with the already-mounted functional hardware components, may be fitted as a complete hardware module into the door structure.

To improve occupant comfort, a conventional vehicle door assembly may incorporate an armrest that extends inward from the interior trim panel into the passenger cabin. In addition to providing a support surface for an occupants forearm, the armrest is often integrated with a door latch release lever and a pull-handle or pull-cup used to open and close the door assembly. The door latch release lever may include a pull-bar handle portion that projects through an opening in the interior trim panel and is pivotable on a release lever chassis that is mounted to the unit carrier panel. Pivotal movement of this handle portion applies tension to a cable that moves a latch mechanism to release the latch and open the door. The vehicle door armrest may also contain a button panel with switches for activating a locking mechanism that prevents the vehicle door assembly from unwantedly opening during or after operation of the vehicle.

### SUMMARY

Presented herein are vehicle armrest assemblies having fore-aft slotting for improved comfort and reduced complexity, methods for making and methods for using such vehicle armrests, and motor vehicles with vehicle door assemblies constructed with such vehicle armrests. By way of non-limiting example, a vehicle door trim panel may include an inboard armrest assembly that is constructed from multiple components that are cooperatively engineered to provide comfort and meet predefined design specifications. Existing armrest designs may include a load-bearing substrate that mounts to the interior trim panel, an injected foam polyurethane (PU) cushion that is mounted onto the substrate, a laminated polymer foam pad that covers the PU cushion, and a flexible outer skin that covers and conceals the PU cushion, foam pad, and armrest substrate. To improve occupant comfort while reducing armrest complexity and cost, disclosed armrest assemblies incorporate a novel armrest substrate design with an elongated, arcuate slot that extends in a fore-aft direction along the length of the armrest. When the armrest is loaded, this fore-aft slotting acts like a spring that enables controlled vertical deflection of the substrate without compromising the structural integrity or functional use of the armrest. By incorporating the substrate slot, the armrest assembly may eliminate the foam cushion while ensuring improved comfort while reducing assembly weight, costs, and complexity.

Aspects of this disclosure are directed to vehicle armrest assemblies having fore-aft slotting for improved occupant comfort and reduced armrest complexity. In an example, a vehicle armrest assembly for a motor vehicle includes an armrest substrate that attaches to an interior surface inside the vehicle's passenger cabin, such as an interior trim panel of a vehicle door assembly, a seatback frame of a vehicle seat assembly, or a hinged lid of a center console compartment. The armrest substrate includes an elastic substrate body with an elongated slot that is defined through the substrate body and extends along a fore-aft length of the armrest such that the armrest substrate elastically deforms under vertical loading conditions. A compressible pad is laminated, adhered, or fastened onto the armrest substrate and covers the substrate body and substrate slot. Likewise, a flexible outer skin is laminated, adhered, or fastened onto and covers the compressible pad. It may be desirable that the vehicle armrest assembly be fabricated as a tripartite sandwich structure that consists essentially of the armrest substrate, compressible pad, and outer skin.

Additional aspects of this disclosure are directed to motor vehicles constructed with vehicle door assemblies having vehicle door trim armrests with fore-aft slotting. As used herein, the terms “vehicle” and “motor vehicle” may be used interchangeably and synonymously to include any relevant vehicle platform, such as passenger vehicles, commercial vehicles, industrial vehicles, tracked vehicles, off-road and all-terrain vehicles (ATV), farm equipment, aircraft, watercraft, spacecraft, etc. In an example, a motor vehicle includes a vehicle body with a passenger compartment, multiple road wheels attached to the vehicle body (e.g., via corner modules coupled to a unibody or body-on-frame chassis), and other standard original equipment. A prime mover, which may be in the nature of an electric traction motor and/or an internal combustion engine (ICE) assembly, is located inside the vehicle body and drives the road wheel(s) to propel the vehicle. One or more vehicle door assemblies are movably mounted to the vehicle body to selectively rotate between open and closed positions.

Continuing with the discussion of the above example, each of the vehicle door assemblies includes a load-bearing door support panel that movably attaches to the vehicle body, e.g., via metal hinge brackets on a body pillar sill. An interior trim panel is mounted, e.g., via trim rivet clips, onto an inboard side of the door support panel, and a door armrest assembly is mounted, e.g., via panhead bolts, onto the interior trim panel inside the passenger cabin. The door armrest assembly includes a load-bearing armrest substrate that is fabricated with an elastic substrate body having an elongated through slot that passes through the substrate body. This substrate slot extends along a fore-aft length of the armrest substrate such that the armrest substrate acts as a spring that elastically deforms when the armrest assembly is subjected to vertical loading conditions. A compressible pad is adhered to the armrest substrate and covers both the substrate body and substrate slot. A flexible outer skin, which is laminated onto the compressible pad, covers and conceals both the compressible pad and the armrest substrate.

Further aspects of this disclosure are directed to manufacturing control processes for making any of the herein described vehicle armrest assemblies and/or vehicle door assemblies. In an example, a method is presented for manufacturing a vehicle armrest assembly for a motor vehicle. The motor vehicle includes a passenger cabin with an interior surface inside that passenger cabin. This representative method includes, in any order and in any combination with any of the above and below disclosed options and features: forming an armrest substrate configured to attach to the interior surface inside the passenger cabin of the motor vehicle, the armrest substrate including an elastic substrate body with an elongated substrate slot defined through the substrate body and extending along a fore-aft length of the armrest substrate such that the armrest substrate elastically deforms when the vehicle armrest assembly is subjected to vertical loading conditions; mounting a compressible pad onto the armrest substrate such that the compressible pad covers the substrate body and the substrate slot; and mounting a flexible outer skin onto the compressible pad such that the outer skin covers the compressible pad and conceals the armrest substrate.

For any of the disclosed vehicle armrest assemblies, motor vehicles, and methods, the armrest's substrate body may include a pair of through-holes that adjoin opposing terminal ends of the substrate slot. These through-holes are shaped and sized to improve the structural integrity of the substrate slot while guiding deflection of the substrate body when the armrest assembly is subjected to vertical loading. In this instance, the substrate slot may have a slot width that is substantially perpendicular to the fore-aft length of the armrest substrate, and each through-hole may be circular with a hole diameter that is greater than the slot width. As another option, the substrate body may be fabricated (e.g., injection molded polypropylene, polymethyl methacrylate, or bulk molding compound) as a single-piece structure that includes a substantially horizontal substrate platform that is integral with a substantially vertical substrate wall, which projects downwards from the substrate platform. In this instance, the substrate slot may be interposed between and structurally separate the substrate platform and the substrate wall.

For any of the disclosed armrest assemblies, motor vehicles, and methods, the armrest substrate may include a series of stopper tabs that project downwards from a bottom edge of the substrate body. These stopper tabs press against the interior surface to limit deflection of the armrest and thereby prevent permanent deformation of the substrate body. In this instance, the stopper tabs may include at least a first stopper tab of a first size located at a first position, a second stopper tab of a second size located at a second position, and a third stopper tab of a third size located at a third position. The stopper sizes may be distinct from one another and the stopper positions may be distinct from one another. As another option, the substrate slot may be arcuate with a first rectilinear slot segment connected to a second rectilinear slot segment via a curved slot segment. The slot segment lengths of the first, second, and curved slot segments may be distinct from one another.

For any of the disclosed armrest assemblies, motor vehicles, and methods, the armrest's compressible pad may include an elongated rib that extends along the fore-aft length of the armrest substrate; this pad rib may project outboard from the compressible pad and into the substrate slot, e.g., occluding the slot. In this instance, an elongated channel may be recessed into an inboard side of the pad rib and extend along the fore-aft length of the armrest substrate. The outer skin of the armrest may include an elongated flap that extends along the fore-aft length of the armrest substrate; this skin flap may project outboard from the outer skin and into the pad channel, e.g., filling the channel. In this instance, the outer skin may include an elongated weld seam that extends along the fore-aft length of the armrest substrate and is recessed into the skin flap. The pad rib, pad channel, skin flap, and weld seam may be substantially coterminous with one another.

For any of the disclosed armrest assemblies, motor vehicles, and methods, the substrate body may be formed, in whole or in part, with a semi-rigid elastomeric material, the compressible pad may be formed, in whole or in part, with an inelastic polymer foam, and the flexible outer skin may be formed, in whole or in part, with an inelastic vinyl material. It may be desirable that the armrest assembly lack a polymeric foam cushion that is interposed between the compressible pad and armrest substrate. As a further option, the armrest substrate may rigidly mount to an armrest base on an inboard surface of a vehicle door interior trim panel with an underside surface of the substrate body spaced from a top surface of the armrest base to thereby enable vertical deflection of the armrest substrate.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an elevated, perspective-view illustration of a representative motor vehicle with an inset view showing a partially exploded, perspective-view illustration of the interior of a vehicle door assembly in accordance with aspects of the present disclosure.

FIG. 2 is an enlarged, perspective-view illustration of a rear portion of a door trim armrest of the representative vehicle door assembly of FIG. 1.

FIG. 3 is a partially exploded, perspective-view illustration of the representative vehicle door trim armrest of FIGS. 1 and 2.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

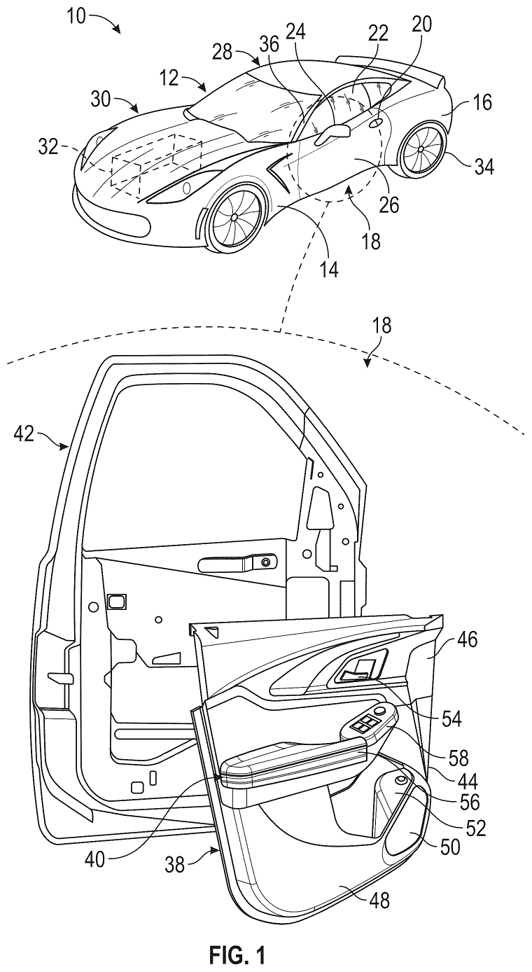

Referring now to the drawings, wherein like reference numbers refer to like features throughout the several views, there is shown in FIG. 1 a representative motor vehicle, which is designated generally at 10 and portrayed herein for purposes of discussion as a couple-style, two-seater automobile. The illustrated automobile 10—also referred to herein as “motor vehicle” or “vehicle” for short—is merely an exemplary application with which aspects of this disclosure may be practiced. In the same vein, implementation of the present concepts for a front driver-side vehicle door assembly should be appreciated as a non-limiting implementation of disclosed features. As such, it will be understood that aspects of this disclosure may be employed for other in-cabin armrest assemblies, may be implemented for other vehicle door assembly architectures, and may be incorporated into any logically relevant type of motor vehicle. Moreover, only select components of the motor vehicle, vehicle door, and armrest assembly are shown and described in detail herein. Nevertheless, the vehicles, door assemblies, and armrests discussed below may include numerous additional and alternative features, and other available peripheral hardware, for carrying out the various methods and functions of this disclosure.

Mounted along port and starboard-side flanks of the automobile 10, e.g., framed within a respective door sill (not visible) located between a front fender panel 14 and a rear quarter panel 16 of a vehicle body 12, are driver-side and passenger-side vehicle door assemblies (only the former of which is visible in FIG. 1 and designated generally at 18). It should be appreciated that the driver-side and passenger-side vehicle door assemblies may be substantially structurally identical, mirrored counterparts to each other; as such, all features described herein with respect to the driver-side door assembly 18 may be likewise incorporated into the passenger-side door assembly. By way of non-limiting example, the driver-side door assembly 18 is constructed with an exterior door handle 20, a movable glass windowpane 22, and a rearview mirror module 24 that is located on an exterior “A-surface” cover panel 26. The vehicle door assembly 18 of FIG. 1 can be pivotably mounted, e.g., via a multi-stage check-spring door hinge (not visible), to a front hinge pillar 36 of the vehicle body 12 to securely close and, when desired, open the door assembly 18 to provide access to the vehicle passenger cabin 28. A prime mover 32, which may be in the nature of an internal combustion engine (ICE) assembly and/or an electric traction motor, is mounted inside an engine bay 30 of the vehicle body 12 and is operable to generate and deliver tractive torque to one or more of the vehicle's road wheels 34 to propel the automobile 10.

Presented within the inset view of FIG. 1 is a partially exploded, perspective-view illustration of the driver-side vehicle door assembly 18, which shows a door trim panel assembly 38 and a door trim armrest assembly 40 aligned with and rigidly mounted onto a door support frame 42. The door support frame 42 (also referred to herein as “support panel”) may function as the primary load-bearing structural member of the vehicle door assembly 18 for transferring loads to fore and aft door frame pillars (commonly referred to as the “A-pillar” and “B-pillar”). Vehicle door assembly 18 is of a multilayer construction with the door support frame 42 sandwiched between, and providing physical support for, the exterior cover panel 26, the interior trim panel assembly 38, the armrest assembly 40, and the door's various electrical and mechanical hardware components. While amendable to multi-piece constructions, the illustrated door support frame 42 may be integrally formed as a single-piece unitary structure, e.g., via stamping, casting, thermoforming, hydroforming, etc. It may be desirable, depending on the intended application, to blank cut and die stamp the door support frame 42 from a more robust, weightier metal, such as steel and alloys thereof, or a lightweight metal, such as aluminum or magnesium.

With continuing reference to the inset view of FIG. 1, the vehicle door's trim panel assembly 38 (also referred to herein as “interior trim panel”) may be typified by various aesthetic, non-load bearing subcomponents. For instance, a lower trim panel 44 may be securely mounted onto an inner surface of the door support frame 42, e.g., by fasteners, rivets, or like elements, such that the lower trim panel 44 protrudes into the vehicle passenger cabin 28. The trim panel assembly's lower trim panel 44 may be fabricated with assorted optional features, such as a lower kick-guard portion 48, an audio speaker 50, and a cubby hole 52. An upper trim panel 46 may be securely mounted onto the inner surface of the door support frame 42, e.g., by fasteners, rivets, or like elements, such that the upper trim panel 46 is positioned above and seats coterminous on the lower trim panel 44. Protruding through a lever opening in the upper trim panel 46 is a door latch release lever 54 that may be manually operated by a vehicle occupant to unlatch and, thus, open the vehicle door assembly 18.

Door trim armrest assembly 40 (also referred to herein as “vehicle armrest assembly”) may act as an energy-absorbing and load-bearing structure that provides support for an occupant's forearm, helping to reduce fatigue, maintain proper posture, and improve overall driving comfort. The door trim armrest assembly 40 may be fabricated with a pull-handle or pull-cup feature 56 which, once assembled to the door's inner support frame 42, acts as a functional gripping surface by which an occupant sitting in the passenger cabin 28 may manually open and close the vehicle door assembly 18. A trim panel switch pack 58 of the type used to operate the vehicle door locks, windows, side mirrors, etc., may be integrated into the trim panel assembly 38 and located at a forward-most end of the armrest assembly 40.

To improve occupant comfort while reducing armrest complexity and cost, disclosed vehicle armrests may incorporate a novel armrest substrate design with an elongated, arcuate slot that enables the armrest to elastically deform in a spring-like manner during vertical loading. When the armrest is in use, for example, the weight of the occupant's arm causes deflection of the assembly due to the position, orientation, and size of the slot. Integrating the slot into the armrest substrate effectively enables the contact surface of the substrate to function like a flat spring, thereby providing a cushioning effect without experiencing permanent deformation. Incorporating the elongated substrate slot into the armrest assembly eliminates the need for an injected polyurethane-foam cushion interposed between the PVC/vinyl skin layer and the load-bearing substrate layer, providing a simpler design with fewer parts while maintaining similar comfort levels.

To help prevent permanent deformation of the armrest assembly during extreme loading conditions, multiple stoppers may be added to predetermined locations of the armrest substrate to militate against excessive bending of the assembly. These stoppers help to limit the maximum deflection of the slot, ensuring that the substrate returns to its original shape after use which, in turn, helps to ensure the longevity and durability of the armrest assembly. A stress-relieving hole—known as a “relief”—may be placed at each end of the elongated substrate slot. These reliefs may serve to guide the direction of substrate deflection, ensuring that the armrest assembly provides consistent support. In addition, the reliefs may help to improve the structural integrity of the slot, enhancing the substrate's overall strength. As a further option, the substrate slot may be aligned with the weld seam in the armrest fascia/topper to avoid any marks in the skin. By incorporating the slot design, stoppers, and reliefs, the door trim armrest achieves a balance between comfort, cost-effectiveness, and structural integrity.

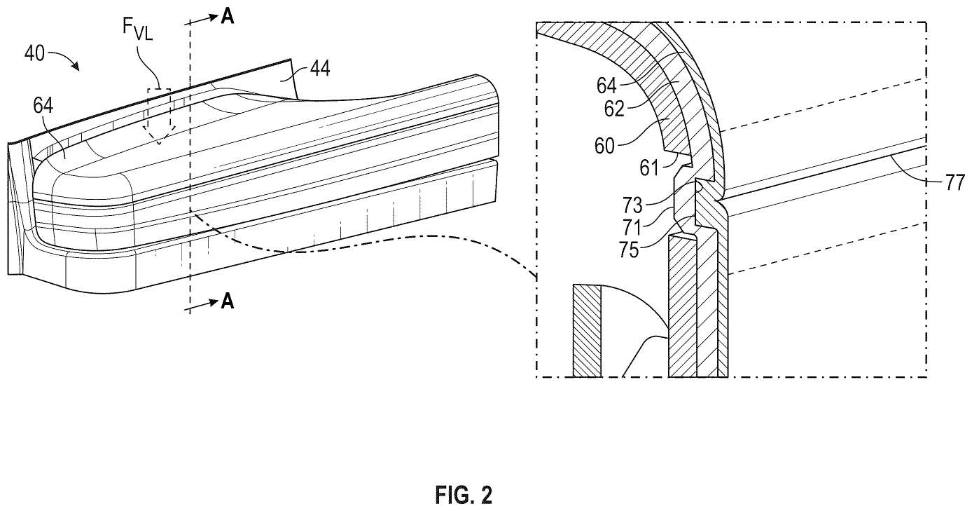

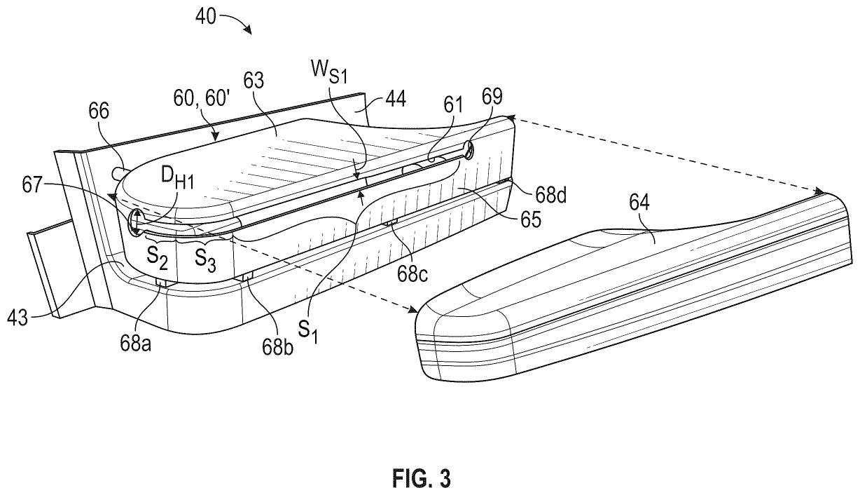

FIG. 2 presents an enlarged, perspective-view illustration of the representative vehicle armrest assembly 40 of FIG. 1 with an inset view showing a section of the assembly 40 taken along line A-A. While illustrated and described as a door trim armrest of a vehicle door assembly, novel features of the vehicle armrest assembly 40 may be incorporated into a vehicle seat-mounted armrest, a center console lid armrest, or any other logically suitable interior vehicle support surface. The vehicle armrest assembly 40 may be a tripartite sandwich structure that is typified by or, if desired, consists essentially of three primary components: an armrest substrate 60, a compressible pad 62, and a flexible outer skin 64. The armrest substrate 60 is a load-bearing structure that securely attaches to the panel assembly's lower trim panel 44. As shown in FIG. 3, for example, the armrest substrate 60 may be rigidly mounted, e.g., via panhead bolts (not shown) threadably mated with complementary threaded receiver bosses 66, to an armrest base 43 on an inboard surface of the vehicle door's lower interior trim panel 44. Once installed, an underside surface of the armrest substrate's main body 60′ is spaced vertically upwards from a topmost surface of the armrest base 43 to thereby enable vertical deflection of the armrest substrate 60. The main body 60′ may be fabricated as a contoured and asymmetrical single-piece structure that is formed, in whole or in part, from a semi-rigid elastomeric material (e.g., injection molded polypropylene (PP), polymethyl methacrylate (PMMA), or bulk molding compound (BMC)).

With collective reference to both FIG. 2 and FIG. 3, the compressible pad 62 may be adhered onto top and side surfaces of the armrest substrate 60 such that the pad 62 covers the substrate's main body 60′ and a substrate slot 61 in the substrate body 60′. The compressible pad 62 may be fabricated as a variable-thickness and generally flat single-piece structure that is formed, in whole or in part, from an inelastic polymer foam (e.g., extruded and skived low-density polyethylene (LDPE) foam). Comparatively, the flexible outer skin 64 may be laminated onto an outer surface of the compressible pad 62 such that the skin 64 covers and conceals both the substrate 60 and pad 62. The armrest assembly's outer skin 64 may be fabricated as a variable-thickness and generally planar single-piece structure that is formed, in whole or in part, from a vinyl polymer material (e.g., polyvinyl chloride (PVC) fabric). It may be desirable that the armrest assembly 40 lack a polymeric foam cushion that is interposed between the substrate 60 and the compressible pad 62.

Occupant comport may be improved with a concomitant reduction in assembly complexity, cost, and weight by incorporating an elongated slot 61 into the armrest assembly 40 of FIGS. 2 and 3. In accord with the illustrated example, the substrate slot 61 is a “through slot” that passes completely through the substrate body 60′ and extends along a fore-aft length of the armrest substrate 60 such that the substrate 60 and, thus, the armrest assembly 40 elastically deforms under vertical loading conditions (indicated by vertical force vector F_{VL} in FIG. 2). This slot 61 may be substantially horizontal, with a substantially constant width, and may extend at least 75% of the length of the substrate body 60′. The substrate body 60′ may be delineated into a substantially horizontal substrate platform 63 and a substantially vertical substrate wall 65 that projects downwards perpendicularly from the substrate platform 63. The substrate slot 61 may be interposed between and separate the substrate platform 63 and the substrate wall 65 such that the substrate platform 63 functions like a flat spring when the armrest assembly 40 is loaded.

The elongated substrate slot 61 may be arcuate with three interconnected slot segments: a substantially horizontal first rectilinear slot segment S₁ that is substantially parallel to the trim panel 44; a substantially horizontal second rectilinear slot segment S₂ that is obliquely angled to the trim panel 44; and a substantially horizontal curved slot segment S₃ that is interposed between and connects the first and second rectilinear slot segments S₁, S₂. The slot lengths of the three interconnected slot segments S₁, S₂, S₃ may be distinct from one another, e.g., with the first slot segment S₁ being the longest slot segment, and the second slot segment S₂ being the shortest slot segment. The three slot segments S₁, S₂, S₃ may be mutually coplanar (as shown) or may each lie in a distinct plane. It is also envisioned that the substrate slot 61 may comprise greater or fewer than three slot segments which may take on alternative shapes, sizes, and orientations from that which are shown in the subject drawings.

To help enhance the strength of the armrest assembly 40, the armrest substrate 60 may be fabricated with a pair of (first and second) relief holes 67 and 69 that pass completely through the substrate body 60′ and adjoin opposing (first and second) terminal ends, respectively, of the substrate slot 61. The two through-hole 67, 69 may be shaped, sized, and positioned to cooperatively guide deflection of the substrate body 60′ when the armrest assembly 40 is subjected to vertical loading F_{VL}. In accord with the illustrated example, the substrate slot 61 has a lateral slot width W_{S1} that is substantially perpendicular to the longitudinal length of the substrate 60 and slot 61; both through-holes 67, 69 may be circular with a hole diameter D_{H1} that is greater than the slot width W_{S1}. Each relief hole 67, 69 may be strategically located at a potential crack site (i.e., a respective longitudinal end of the slot 61) to relieve bending stress concentrations in the substrate 60 and, in so doing, help to prevent crack initiation and propagation.

To help prevent permanent deformation of the armrest assembly 40, the armrest substrate 60 may be fabricated with multiple stopper tabs 68a-68d that project downwards from a bottom edge of the substrate body 60′ and, when the assembly 40 is loaded, press against an interior surface of the trim panel 44 to thereby limit deflection of the substrate body 60′. As best seen in FIG. 3, for example, the armrest substrate 60 is formed with four polyhedral stopper tabs: a first stopper tab 68a of a first size located at a first position, a second stopper tab 68b of a second size located at a second position, a third stopper tab 68c of a third size located at a third position, and a fourth stopper tab 68d of a fourth size located at a fourth position. The respective stopper sizes of the four stopper tabs 68a-68d may be the same or, if desired, may be distinct from one another. On the other hand, the respective positions of the four stopper tabs 68a-68d are distinct from one another (i.e., the tabs are shown spaced from one another along the bottom edge of the substrate body 60′).

Turning to the sectional view inset within FIG. 2, the substrate slot 61 may be aligned with an elongated stitch/seam in the armrest's outer skin 64 (also referred to as “armrest fascia” or “topper”) to avoid unwanted fracturing in the skin's outer surface. In particular, the armrest's compressible pad 62 is shown with an elongated rib 71 that extends along the fore-aft length of the armrest substrate 60; this pad rib 71 may project outboard from the compressible pad 62 and into the substrate slot 61, e.g., partially filling and occluding the slot 61. In this instance, an elongated channel 73 may be recessed into an inboard side of the pad rib 71 and extend along the fore-aft length of the armrest substrate 60. The outer skin 64 of the armrest assembly 40 may include an elongated flap 75 that extends along the fore-aft length of the armrest substrate 60; this skin flap 75 may project outboard from the outer skin 64 and into the pad channel 73, e.g., substantially filling the channel 73. In this instance, the outer skin 64 may include an elongated stitch or weld seam 77 that extends along the fore-aft length of the armrest substrate 60 and is recessed into the skin flap 75. It may be desirable that the pad rib 71, pad channel 73, skin flap 75, and stitch/weld seam 77 be substantially coterminous with one another.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A vehicle armrest assembly for a motor vehicle, the motor vehicle having a passenger cabin with an interior surface, the vehicle armrest assembly comprising:
an armrest substrate configured to attach to the interior surface inside the passenger cabin, the armrest substrate including an elastic substrate body with an elongated substrate slot defined through the substrate body and extending along a fore-aft length of the armrest substrate such that the armrest substrate elastically deforms under vertical loading conditions;
a compressible pad seated on the armrest substrate and covering the substrate body and the substrate slot; and
a flexible outer skin seated on and covering the compressible pad.

2. The vehicle armrest assembly of claim 1, wherein the substrate body further includes first and second through-holes adjoining opposing first and second terminal ends, respectively, of the substrate slot, the first and second through-holes configured to guide deflection of the substrate body when the armrest assembly is subjected to the vertical loading conditions.

3. The vehicle armrest assembly of claim 2, wherein the substrate slot has a slot width substantially perpendicular to the fore-aft length of the armrest substrate, and the first and second through-holes are circular with a hole diameter greater than the slot width.

4. The vehicle armrest assembly of claim 1, wherein the substrate body is a single-piece structure including a substantially horizontal substrate platform and a substantially vertical substrate wall projecting downwards from the substrate platform, and wherein the substrate slot is interposed between and separates the substrate platform and the substrate wall.

5. The vehicle armrest assembly of claim 1, wherein the armrest substrate further includes a plurality of stopper tabs projecting downwards from a bottom edge of the substrate body and configured to press against the interior surface to thereby prevent permanent deformation of the substrate body.

6. The vehicle armrest assembly of claim 5, wherein the plurality of stopper tabs includes a first stopper tab of a first size located at a first position, a second stopper tab of a second size located at a second position, and a third stopper tab of a third size located at a third position.

7. The vehicle armrest assembly of claim 1, wherein the compressible pad includes an elongated pad rib extending along the fore-aft length of the armrest substrate, the pad rib projecting from the compressible pad into the substrate slot.

8. The vehicle armrest assembly of claim 7, wherein the compressible pad defines an elongated pad channel recessed into the pad rib, the outer skin including an elongated skin flap extending along the fore-aft length of the armrest substrate, the skin flap projecting from the outer skin into the pad channel.

9. The vehicle armrest assembly of claim 8, wherein the outer skin defines an elongated weld seam recessed into skin flap, and wherein the pad rib, the pad channel, the skin flap, and the weld seam are substantially coterminous with one another.

10. The vehicle armrest assembly of claim 1, wherein the substrate slot is arcuate with a first rectilinear slot segment of a first length connected to a second rectilinear slot segment of a second length, less than the first length, via a curved slot segment.

11. The vehicle armrest assembly of claim 1, wherein the substrate body is formed with a semi-rigid elastomeric material, the compressible pad is formed with an inelastic polymer foam, and the flexible outer skin is formed with an inelastic vinyl material.

12. The vehicle armrest assembly of claim 1, characterized by a lack of a polymeric foam cushion interposed between the compressible pad and the armrest substrate.

13. The vehicle armrest assembly of claim 1, wherein the motor vehicle includes a vehicle door assembly with an interior trim panel defining the interior surface as an armrest base, and wherein the armrest substrate rigidly mounts to the interior trim panel with an underside surface of the substrate body spaced from a top surface of the armrest base to thereby enable vertical deflection of the armrest substrate.

14. A motor vehicle, comprising:
a vehicle body including a passenger cabin;
a plurality of road wheels attached to the vehicle body;
a prime mover attached to the vehicle body and configured to drive at least one of the road wheels to thereby propel the motor vehicle; and
a vehicle door assembly including a load-bearing door support panel movably attached to the vehicle body, an interior trim panel mounted on an inboard side of the door support panel, and a door armrest assembly mounted onto an armrest base of the interior trim panel inside the passenger cabin, the door armrest assembly including:
an armrest substrate including an elastic substrate body with an elongated substrate slot defined through the substrate body, the substrate slot extending along a fore-aft length of the armrest substrate such that the armrest substrate elastically deforms when the armrest assembly is subjected to vertical loading conditions;
a compressible pad adhered to the armrest substrate and covering the substrate body and the substrate slot; and
a flexible outer skin laminated onto and covering the compressible pad.

15. A method of manufacturing a vehicle armrest assembly for a motor vehicle, the motor vehicle having a passenger cabin with an interior surface, the method comprising:
forming an armrest substrate configured to attach to the interior surface inside the passenger cabin of the motor vehicle, the armrest substrate including an elastic substrate body with an elongated substrate slot defined through the substrate body and extending along a fore-aft length of the armrest substrate such that the armrest substrate elastically deforms when the vehicle armrest assembly is subjected to vertical loading conditions;
mounting a compressible pad onto the armrest substrate such that the compressible pad covers the substrate body and the substrate slot; and
mounting a flexible outer skin onto the compressible pad such that the outer skin covers the compressible pad and conceals the armrest substrate.

16. The method of claim 15, wherein the substrate body further includes first and second through-holes adjoining opposing first and second terminal ends of the substrate slot, the first and second through-holes configured to guide deflection of the substrate body when the armrest assembly is subjected to the vertical loading conditions.

17. The method of claim 15, wherein the substrate body is a single-piece structure including a substantially horizontal substrate platform and a substantially vertical substrate wall projecting downwards from the substrate platform, and wherein the substrate slot is interposed between and separates the substrate platform and the substrate wall.

18. The method of claim 15, wherein the armrest substrate further includes a plurality of stopper tabs projecting downwards from a bottom edge of the substrate body and configured to press against the interior surface to thereby prevent permanent deformation of the substrate body.

19. The method of claim 15, wherein the compressible pad includes an elongated pad rib extending along the fore-aft length of the armrest substrate, the pad rib projecting from the compressible pad into the substrate slot.

20. The method of claim 19, wherein the compressible pad defines an elongated pad channel recessed into the pad rib, the outer skin including an elongated skin flap extending along the fore-aft length of the armrest substrate, the skin flap projecting from the outer skin into the pad channel.
